(19) United States
(12) Patent Application Publication
(10) Pub. No.: US 2017/0372242 A1
(43) Pub. Date: Dec. 28, 2017

(54) SYSTEM TO MONITOR AND PROCESS NOISE LEVEL EXPOSURE DATA

(71) Applicant: Hartford Fire Insurance Company, Hartford, CT (US)

(72) Inventors: Saleh Ahmed Alsubai, West Hartford, CT (US); Daniel T. Kelly, Cromwell, CT (US); Susan A. Rickard, West Suffield, CT (US); Robert Jerard Ross, Tolland, CT (US)

(21) Appl. No.: 15/193,347

(22) Filed: Jun. 27, 2016

(51) Int. Cl. G06Q 10/06; G06Q 40/08; H04W 4/00; G10L 21/10; G06F 3/0484

(52) U.S. Cl. CPC G06Q 10/0635; G06Q 40/08; H04W 4/005; G06F 3/04842; G10L 21/10

(57) ABSTRACT

A plurality of stationary noise sensors may each include a microphone to sense noise, a power source, and a communication device to transmit data about noise sensed by the microphone. A plurality of mobile noise sensors may each include a microphone to sense noise, a power source, and a communication device to transmit data about noise sensed by the microphone. A noise information hub may receive data from the stationary noise sensors and mobile noise sensors and provide indications associated with the received data via a cloud-based application. An analytics platform may receive the indications and analyze them to determine noise level exposure information for each of a plurality of locations within a workplace. The analytics platform may also transmit information to facilitate rendering of an interactive graphical operator interface that displays a map-based presentation of the noise level exposure information and prior noise-related results for each of the locations.

### FIELD

The present invention relates to computer systems and, more particularly, to computer systems associated with monitoring and/or processing noise level exposure data (e.g., associated with a workplace).

### BACKGROUND

An enterprise may want to monitor and/or process noise level exposure data. For example, an employer may want to monitor noise level exposure data to help protect employees from hearing loss caused by loud and/or sustained noise levels. In some cases, an employer (or a party associated with disability insurance claims) may have an industrial hygienist visit a work site and perform a noise site survey to help understand the noise levels workers are exposed to during a typical workday. Such an approach, however, can be an expensive and error-prone process. For example, the industrial hygienist might not realize that different levels of noise are generated during different times of day, days of the week, etc. (e.g., due to different machines being operated and/or different processes being performed). As a result, improved ways to facilitate a monitoring and/or processing of noise level exposure data may be desired.

### SUMMARY

According to some embodiments, systems, methods, apparatus, computer program code and means may facilitate a monitoring and/or processing of noise level exposure data. In some embodiments, a plurality of stationary noise sensors may each include a microphone to sense noise, a power source, and a communication device to transmit data about noise sensed by the microphone. A plurality of mobile noise sensors may each include a microphone to sense noise, a power source, and a communication device to transmit data about noise sensed by the microphone. A noise information hub may receive data from the stationary noise sensors and mobile noise sensors and provide indications associated with the received data via a cloud-based application. An analytics platform may receive the indications and analyze them to determine noise level exposure information for each of a plurality of locations within a workplace. The analytics platform may also transmit information to facilitate rendering of an interactive graphical operator interface that displays a map-based presentation of the noise level exposure information and prior noise-related results for each of the locations.

Some embodiments provide: means for collecting, via a plurality of stationary noise sensors, data about noise sensed by each of the plurality of stationary noise sensors; means for collecting, via a plurality of mobile noise sensors, data about noise sensed by each of the plurality of mobile noise sensors; means for receiving, at a noise information hub, the data from the plurality of stationary noise sensors and the plurality of mobile noise sensors; means for providing, from the noise information hub, indications associated with the received data via a communication network; means for receiving, by an enterprise analytics platform, the indications associated with the received data via the communication network; means for analyzing, by the enterprise analytics platform, the received indications to determine noise level exposure information for each of a plurality of locations within the site of the enterprise; and means for transmitting, from the enterprise analytics platform, information to facilitate rendering of an interactive graphical operator interface, the interactive graphical operator interface displaying a map-based presentation of the noise level exposure information and prior noise-related results for each of the plurality of locations.

A technical effect of some embodiments of the invention is an improved, secure, and computerized method to facilitate a monitoring and/or processing of noise level exposure data. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method that might be performed in accordance with some embodiments.

FIG. 3 illustrates an interactive operator display in accordance with some embodiments.

FIG. 4 is a block diagram of a stationary noise sensor according to some embodiments.

FIG. 5 is an example of a mobile noise sensor according to some embodiments.

FIG. 6 illustrates an alert method that might be performed in accordance with some embodiments.

FIG. 7 illustrates an alert and dashboard display in accordance with some embodiments.

FIG. 8 illustrates a noise level exposure system status display according to some embodiments.

FIG. 9 is block diagram of an industrial workplace according to some embodiments of the present invention.

FIG. 10 illustrates an insurance rating method that might be performed in accordance with some embodiments.

FIG. 11 is a flow diagram associated with an Internet of Things approach according to some embodiments.

FIG. 12 is block diagram of a noise level exposure tool or platform according to some embodiments of the present invention.

FIG. 13 is a tabular portion of a noise information database according to some embodiments.

FIG. 14 illustrates an overall enterprise method that might be performed in accordance with some embodiments.

FIG. 15 illustrates a system associated with a predictive model according to some embodiments.

FIG. 16 is a block diagram of an air quality measurement system in accordance with some embodiments.

FIG. 17 illustrates an interactive operator air quality display in accordance with some embodiments.

FIG. 18 illustrates an interactive operator display on a portable device in accordance with some embodiments.

### DETAILED DESCRIPTION

The present invention provides significant technical improvements to facilitate a monitoring and/or processing of noise level exposure data, predictive modeling, and dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the areas of noise level exposure monitoring and/or processing by providing benefits in data accuracy, data availability, and data integrity, and such advances are not merely a longstanding commercial practice. The present invention provides improvement beyond a mere generic computer implementation as it involves the processing and conversion of significant amounts of data in a new beneficial manner as well as the interaction of a variety of specialized client and/or third party systems, networks and subsystems. For example, in the present invention information may be processed, forecast, and/or predicted via a analytics engine and results may then be analyzed efficiently to evaluate the safety of a workplace, thus improving the overall performance of an enterprise system, including message storage requirements and/or bandwidth considerations (e.g., by reducing a number of messages that need to be transmitted via a network). Moreover, embodiments associated with predictive models might further improve worker performance, predictions of employee claims, resource allocation decisions, etc.

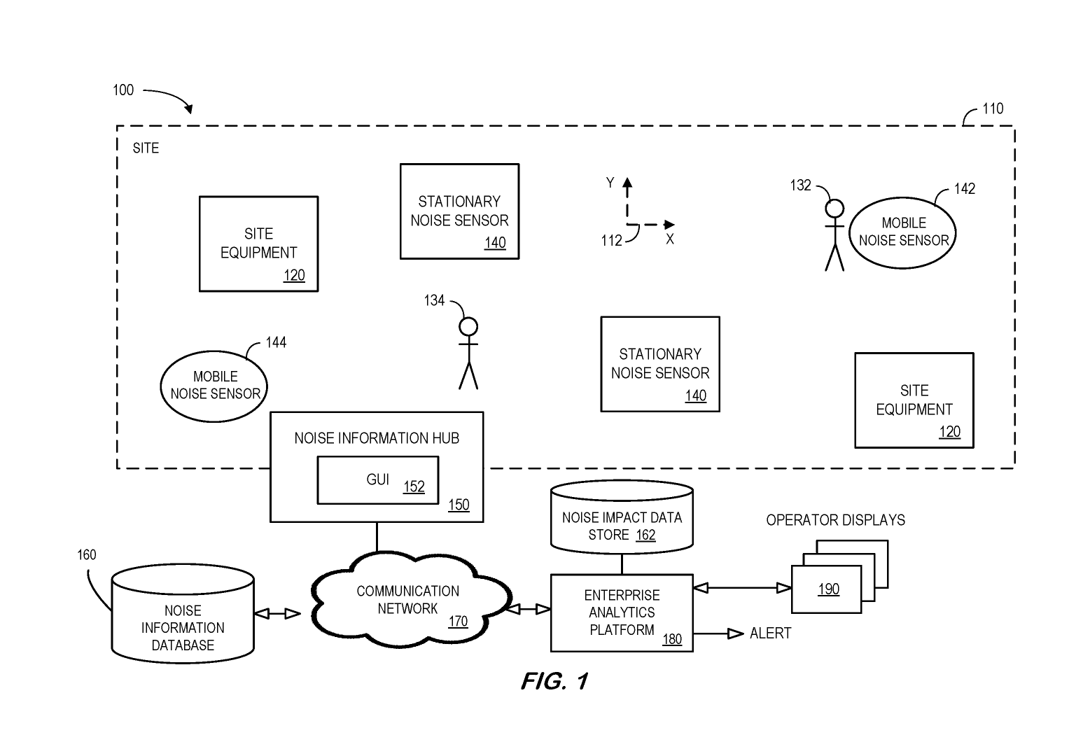

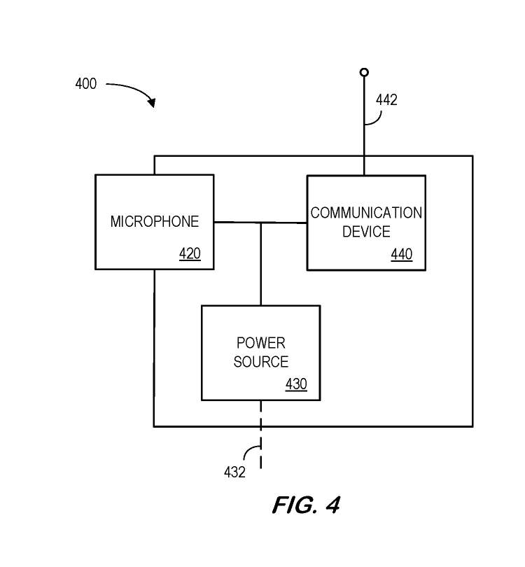

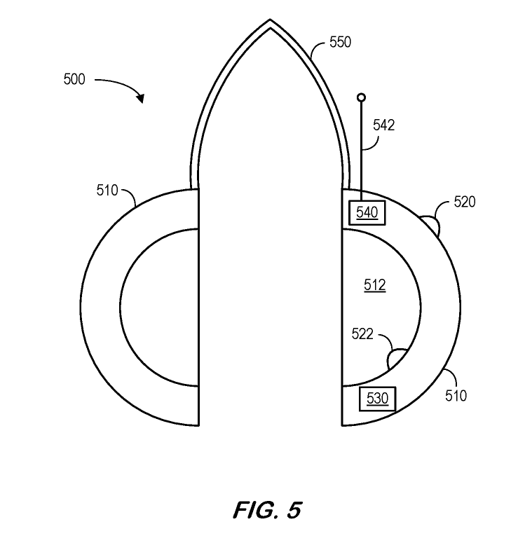

An enterprise, such as an employer, may want to monitor and/or process noise level exposure data. For example, an employer may want to monitor noise level exposure data to help protect employees from hearing loss that might be caused by prolonged exposure to loud noises. To help prevent such damage, an insurer associated with disability insurance claims might have an industrial hygienist visit a work site to perform a noise site survey to help understand the noise levels that workers are exposed to during a typical workday. Such an approach, however, can be an expensive and error-prone process. For example, the industrial hygienist might not realize that different levels of noise are generated during different times of day, days of the week, etc. As a result, improved ways to facilitate a monitoring and/or processing of noise level exposure data may be desired. FIG. 1 is block diagram of a system 100 associated with a site 110 where site equipment 120 may be operated by workers 132, 134 (e.g., creating noise) according to some embodiments of the present invention. In particular, the system 100 includes a noise information hub 150 that may receive information from a plurality of stationary noise sensors 140 (described with respect to FIG. 4) and/or mobile noise sensors 142, 144 (described with respect to FIG. 5). Note that the site equipment 120 and workers 132, 134 may be moved around to various locations within the site 110 (e.g., as indicated by axis 112). Further note that a mobile noise sensor might be associated with a worker (e.g., mobile sensor 142 might be worn by worker 142) or may be independently mobile (e.g., a self-driving sensor).

According to some embodiments, the noise information hub 150 exchanges data with a noise information database 160 and/or an enterprise analytics platform via a communication network 170. For example, a Graphical User Interface (“GUI”) 152 of the noise information hub 150 might transmit information to facilitate a rendering of an interactive graphical operator interface display 190 and/or the creation of electronic alert messages, automatically created employee and/or site recommendations, etc. According to some embodiments, the noise information hub 150 may instead store this information in a local database.

The noise information hub 150 and/or enterprise analytics platform 180 may receive a request for a display from a requestor device. For example, an employer might use his or her smartphone to submit the request to the noise information hub 150. Responsive to the request, the noise information hub 150 might access information from the noise information database 160 (e.g., associated with noise level exposures over a period of time). The noise information hub 150 and/or enterprise analytics platform 180 may then use the GUI 152 to render operator displays 190. According to some embodiments, an operator may access secure site 110 information through a validation process that may include a user identifier, password, biometric information, device identifiers, geographic authentication processes, etc. According to some embodiments, the enterprise analytics platform 180 may further access electronic records from a noise impact data store 162. The noise impact data store 162 might, for example, store information about prior noise-related results associated with an enterprise (and each result might be associated with a location of the enterprise).

The noise information hub 150 and/or enterprise analytics platform 180 might be, for example, associated with a Personal Computer (“PC”), laptop computer, smartphone, an enterprise server, a server farm, and/or a database or similar storage devices. The noise information hub 150 and/or enterprise analytics platform 180 may, according to some embodiments, be associated with an insurance provider.

According to some embodiments, an “automated” noise information hub 150 may facilitate the provision of noise exposure level information to an operator. For example, the noise information hub 150 may automatically generate and transmit electronic alert messages (e.g., when a noise incident occurs) and/or site/employee recommendations. As used herein, the term “automated” may refer to, for example, actions that can be performed with little (or no) intervention by a human.

As used herein, devices, including those associated with the noise information hub 150 and any other device described herein may exchange information via any communication network 170 which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The noise information hub 150 and/or enterprise analytics platform 180 may store information into and/or retrieve information from the noise information database 160. The noise information database 160 might be associated with, for example, an employer, an insurance company, an underwriter, or a claim analyst and might also store data associated with past and current insurance claims (e.g., workers' compensation insurance claims associated with hearing loss). The noise information database 160 may be locally stored or reside remote from the noise information hub 150. As will be described further below, the noise information database 160 may be used by the noise information hub 150 to generate and/or calculate noise level exposure data. Note that in some embodiments, a third party information service may communicate directly with the noise information hub 150 and/or enterprise analytics platform 180. According to some embodiments, the noise information hub 150 communicates information associated with a simulator and/or a claims system to a remote operator and/or to an automated system, such as by transmitting an electronic file to an underwriter device, an insurance agent or analyst platform, an email server, a workflow management system, a predictive model, a map application, etc.

Although a single noise information hub 150 and enterprise analytics platform 180 is shown in FIG. 1, any number of such devices may be included. Moreover, various devices described herein might be combined according to embodiments of the present invention. For example, in some embodiments, the noise information hub 150, enterprise analytics platform 180, and/or noise information database 160 might be co-located and/or may comprise a single apparatus.

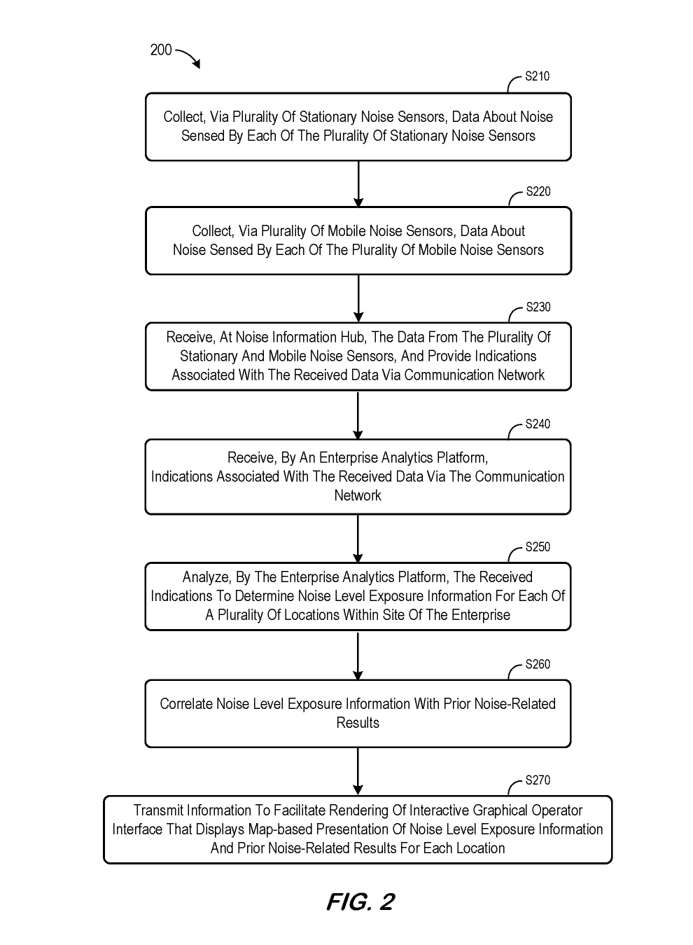

Note that the system 100 of FIG. 1 is provided only as an example, and embodiments may be associated with additional elements or components. According to some embodiments, the elements of the system 100 facilitate an exchange of information. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, data about noise sensed by each of a plurality of “stationary” noise sensors may be collected. Each stationary noise sensor might include, for example, a microphone to sense noise, a power source (e.g., associated with a battery, a re-chargeable battery, and/or an Alternating Current (“AC”) power adapter), and a communication device, coupled to the microphone and the power source, to transmit data about noise sensed by each of the plurality of stationary noise sensors. As used herein, a sensor may be stationary if it is not typically to move between locations (although the sensor might be occasionally moved from one location to another).

At S220, data about noise sensed by each of a plurality of “mobile” noise sensors may be collected. Each mobile noise sensor might include, for example, a microphone to sense noise, a power source (e.g., associated with a battery and/or a re-chargeable battery), and a communication device, coupled to the microphone and the power source, to transmit data about noise sensed by each of the plurality of mobile noise sensors. As used herein, a sensor may be mobile if it often moves from one location to another (although the sensor might remain at one location for a period of time). By way of example only, a mobile noise sensor might be associated with a smartphone, a tablet computer, an activity tracker, a headphone or earmuff device, an earplug, a hardhat, a work vest, work shoes, safety goggles, a lanyard or badge, a clipboard, work gloves, a self-driving device, and a drone.

At S230, a noise information hub may receive data from the plurality of stationary noise sensors and the plurality of mobile noise sensors. The noise information hub may also provide indications associated with the received data via a communication network (e.g., via a cloud-based application).

At S240, an enterprise analytics platform may receive the indications associated with the received data via the communication network. At S250, the enterprise analytics platform may analyze the received indications to determine noise level exposure information for each of a plurality of locations within a site of an enterprise. At S260, the enterprise analytics platform may correlate noise level exposure information with prior noise-related results (e.g., what levels of noise level exposure resulted in a higher likelihood of a particular result occurring?). The results might be associated with, for example, workers' compensation insurance claims, quarterly hearing tests, etc. At S270, the enterprise analytics platform may transmit information to facilitate rendering of an interactive graphical operator interface that displays a map-based presentation of the noise level exposure information and prior noise-related results for each of the plurality of locations. According to some embodiments, the interactive graphical operator interface further includes indications of noise level exposure incidents or events.

According to some embodiments, an enterprise analytics platform may also automatically generate an electronic alert message based on the noise level exposure information. Moreover, the enterprise may be associated with an employer and the electronic alert message might further be based on: an employee location, an employee age, an employee gender, an industry standard, an employee protective equipment status, a length of time, a potential cause of a noise level event, and/or an indication of a remedial action. For example, the enterprise analytics platform might recommend that a 45 year old's work be removed from a relatively noisy environment for two hours in the afternoon (based on his or her actual noise level exposure in the morning). According to some embodiments, selection of a location via the interactive graphical operator interface results in a display of detailed noise level exposure information about that location (e.g., a particular rating or decibel level).

In some embodiments, the enterprise analytics platform may store noise level exposure information representing a period of time (e.g., data representing the last thirty working days). Moreover, the noise level exposure information representing the period of time might be used to calculate a noise level exposure rating for the enterprise (e.g., an employer might be classified as “moderately noisy”). According to some embodiments, the noise level exposure rating is an input to an insurance underwriting module that outputs at least one insurance based parameter (e.g., associated with an insurance premium, a deductible value, a co-payment, an insurance policy endorsement, and/or an insurance limit value). For example, an employer classified as “not noisy” might receive a percent or fixed premium discount for disability insurance (e.g., because fewer hearing-related claims might be expected as compared to “very noisy” employers).

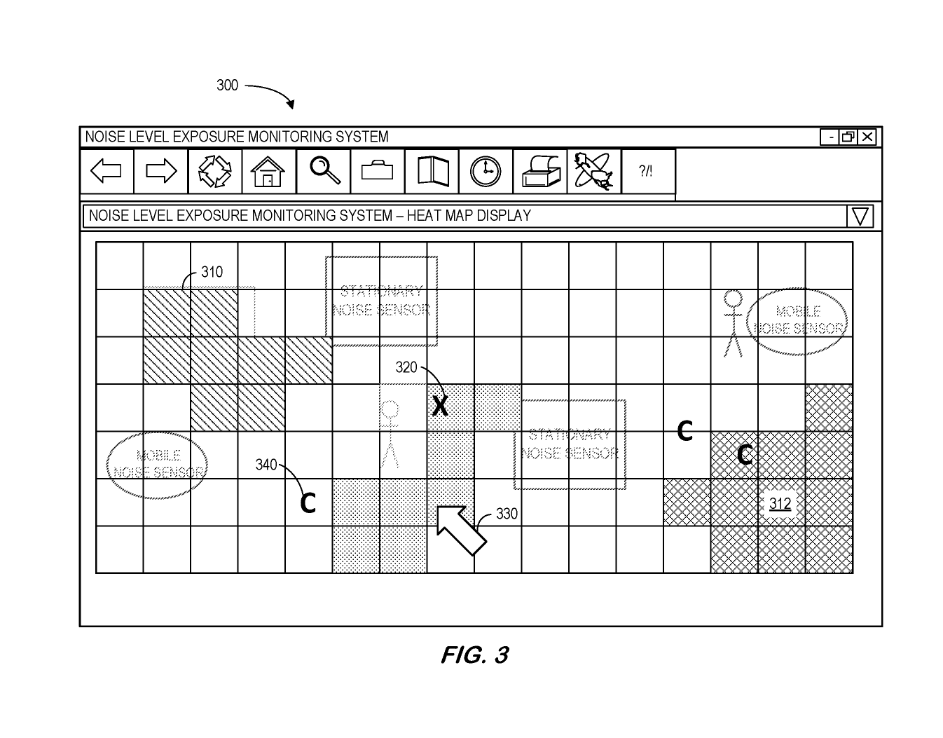

FIG. 3 illustrates an interactive operator display 300 in accordance with some embodiments. The display 300 includes a “heat map” type rendering including areas 310, 312 that signify particular levels of noise exposure. As used herein, the phrase “heat map” may refer to a graphical representation of data where individual values contained in a matrix are represented as colors or other human readable features. In the example of FIG. 3, a first area 310 (e.g., near particular site equipment) might represent a potentially dangerous level of noise exposure and/or a place where workers might need to take special precautions (e.g., by wearing sound-reducing headphones). Note that the display 300 may facilitate an understanding of how different sources of noise interact with each other (e.g., to amplify or otherwise adjust the effect of the noise). According to some embodiments, the display 300 may further include icons 320 associated with an occurrence of a noise incident (e.g., a location where it is known that an employee was exposed to a potentially harmful level of noise). In some embodiments, an operator of the display 300 may use a computer pointer 330 to select an area to receive more detailed information about noise level exposure associated with that location. According to some embodiments, the display 300 further includes indications of prior noise related results 340, such as workers' compensation insurance claims for hearing damage (“C”) that have been filed in connection with various locations.

FIG. 4 is a block diagram of a stationary noise sensor 400 according to some embodiments. The stationary noise sensor 400 (and other stationary noise sensors) may be used to collect data about noise level exposure. The stationary noise sensor 400 might include, for example, a microphone 420 to sense noise, a power source 430 (e.g., associated with a battery, a re-chargeable battery with an 8 hour runtime, and/or an AC power adapter 432), and a communication device 440 (e.g., with a wireless antenna 442), coupled to the microphone 420 and the power source 430, to transmit data about noise level exposure. As used herein, the sensor 400 may be stationary if it is not typically to move between locations (although the sensor 400 might be occasionally moved from one location to another). Note that any of the sensors provided herein might be associated with an ability to identify noise sources, sound power levels, directivity, locations, and/or time frames.

FIG. 5 is an example of a mobile noise sensor 500 according to some embodiments. The mobile noise sensor 500 (and other mobile noise sensors) may be used to collect data about noise level exposure. According to some embodiments, the mobile noise sensor 500 may be a self-driving device (e.g., a movable robot or flying drone). In other embodiments, the mobile noise sensor 500 might be worn by or otherwise be associated with a worker. In the example of FIG. 5, the mobile noise sensor comprises headphones or earmuffs that may be worn by a worker while or she is at a site being monitored. Other examples of wearable noise sensors include a smartphone, a tablet computer, an activity tracker, a hardhat, a work vest, work shoes, safety goggles, a lanyard or badge, a clipboard, and/or work gloves. The mobile noise sensor 500 might include, for example, a pair of earpiece bodies 510, joined by a band 550, at least one of the bodies 510 having a first microphone 520 outside of the body 510 (e.g., to monitor noise external to the headphone) and a second microphone 522 within the body 510 (e.g., to monitor noise proximate to the worker's ear). The mobile noise sensor 500 may further include a power source 530 (e.g., associated with a battery and/or a re-chargeable battery) and a communication device 540, coupled to the microphones 520, 522 and the power source 530, to transmit data about noise via a wireless antenna 542. As used herein, the sensor 500 may be mobile if it often moves from one location to another (although the sensor 500 might remain at one location for a period of time). Note that information from multiple noise sensors (stationary and/or mobile) may be used to triangulate, estimate, or “pinpoint” a source of a noise and/or noise levels at locations between sensors. Moreover, a comparison of data from the first microphone 520 and the second microphone 522 may be used to imply whether or not an employee is correctly wearing the headphone (e.g., if the two microphones 520, 522 are detecting similar levels of noise, he or she is probably not wearing the headphone correctly).

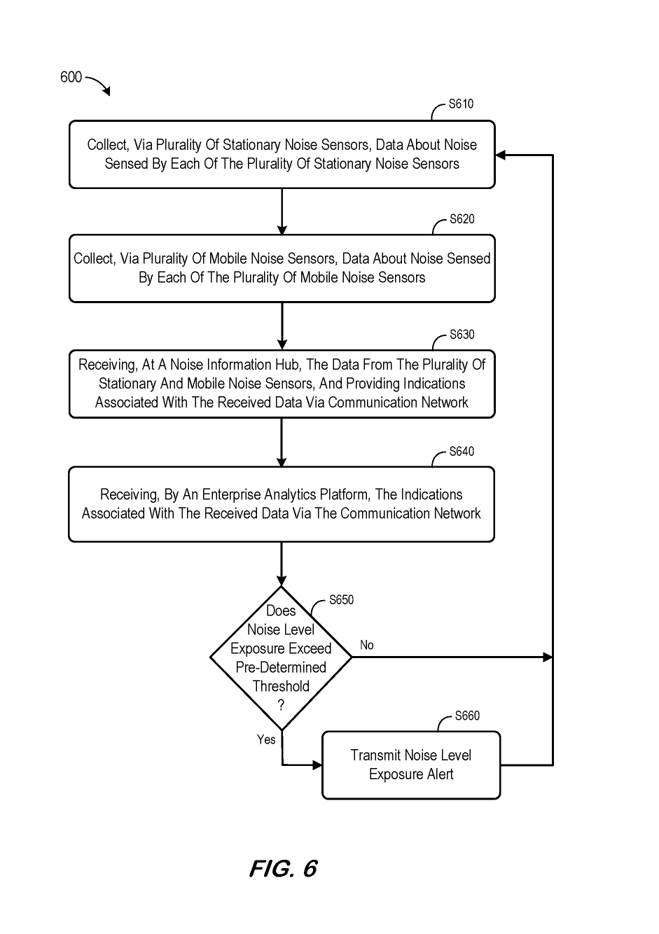

FIG. 6 illustrates an alert method 600 that might be performed in accordance with some embodiments. At S610, data about noise sensed by each of a plurality of stationary noise sensors may be collected. At S620, data about noise sensed by each of a plurality of mobile noise sensors may be collected. At S630, a noise information hub may receive data from the plurality of stationary noise sensors and the plurality of mobile noise sensors. The noise information hub may also provide indications associated with the received data via a communication network (e.g., via a cloud-based application).

At S640, an enterprise analytics platform may receive the indications associated with the received data via the communication network. The enterprise analytics platform may analyze the received indications to determine noise level exposure information for each of a plurality of locations within a site of an enterprise (e.g., to facilitate rendering of an interactive graphical operator interface that displays a map-based presentation of the noise level exposure information for each of the plurality of locations). At S650, the enterprise analytics platform may automatically determine if noise level exposure exceeds a pre-determined threshold The threshold might be associated with, for example, Occupational Safety and Health Administration (“OSHA”) guidelines or industry standards. If the threshold is not exceeded at S650, the process may continue at S610 (e.g., collecting data). If the threshold is exceeded at S650, the enterprise analytics platform may automatically generate and transmit an electronic alert message at S660 based on the noise level exposure information. The electronic alert message might also be based on, for example, an employee location, an employee age, an employee gender, an employee protective equipment status (e.g., is he or she wearing earplugs), a length of time, a potential cause of a noise level event, and/or an indication of a remedial action. For example, the enterprise analytics platform might recommend that all workers at the site be removed for 30 minutes due to help reduce the risk of hearing damage. Instead of a pre-determined threshold, the process at S650 might dynamically analyze the data searching for unusual levels of noise and/or conditions outside of a normal range of conditions.

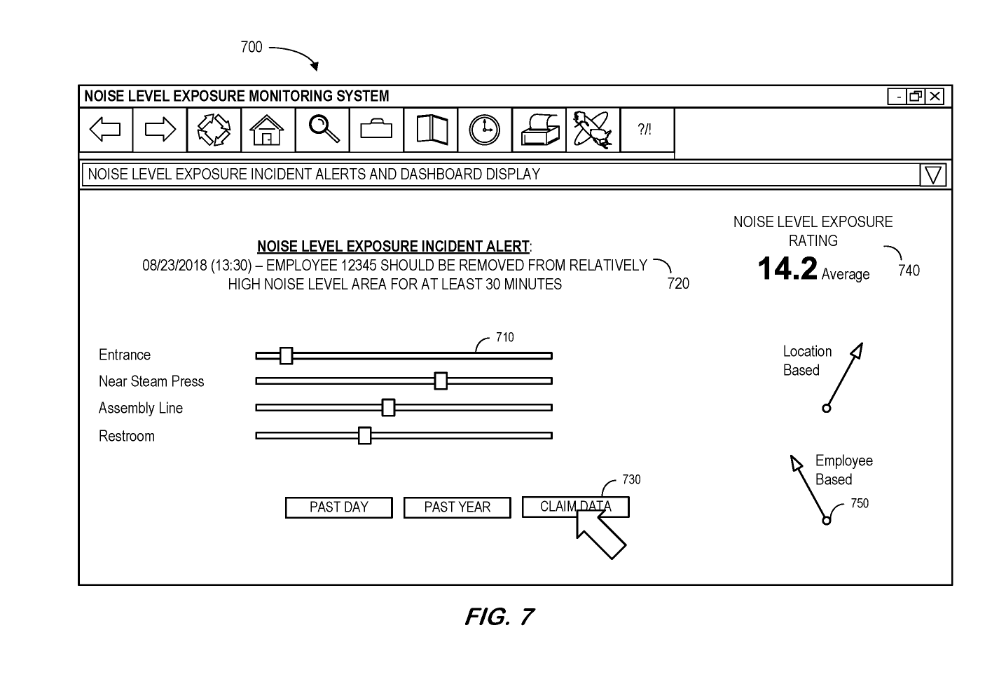

In some embodiments, an enterprise analytics platform may store noise level exposure information representing a period of time (e.g., data representing the previous year). Moreover, the noise level exposure information representing the period of time might be used to calculate a noise level exposure rating for the enterprise (e.g., an employer might be classified as “moderately noisy”). FIG. 7 illustrates an alert and dashboard display 700 that includes noise level exposures 710 for a plurality of site locations in accordance with some embodiments. The display 700 also includes an example of an alert message 720 that might be automatically transmitted to a supervisor and operator selectable options 730 (e.g., to view data associated with a particular time period, disability claim data, etc.). According to some embodiments, the display may further include an overall noise level exposure rating 740 and/or classification (e.g., “average”) and/or dashboard-type display elements 750 (e.g., location-based and/or employee-based display dials).

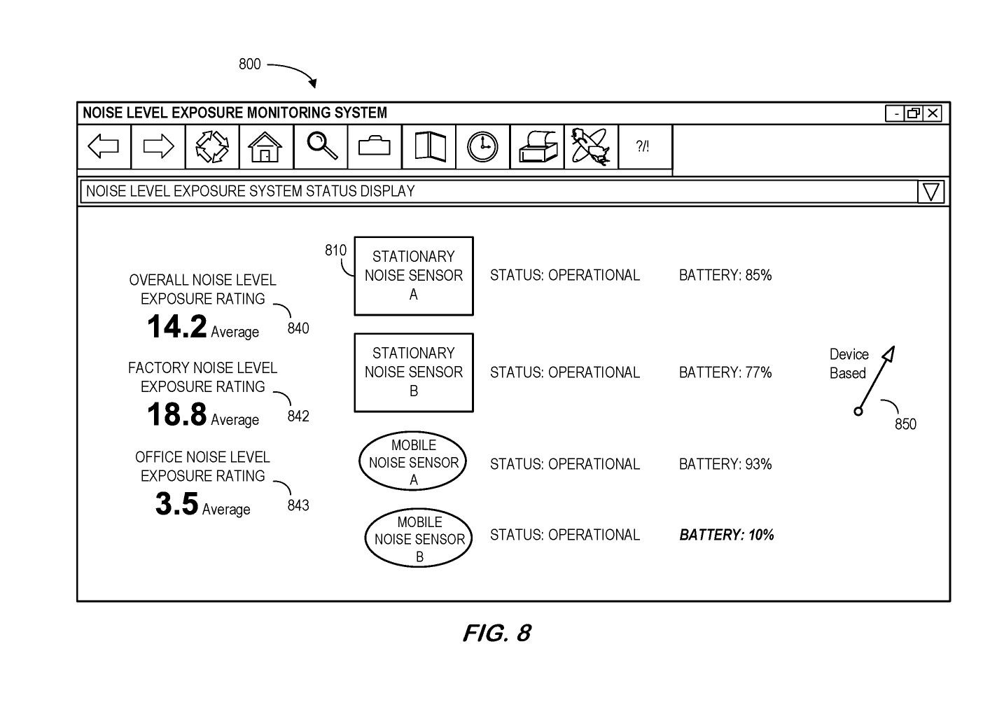

FIG. 8 illustrates a system status display 800 that includes both an overall noise exposure rating 840 and ratings 842, 844 associated with sub-regions, zones, business units, etc. of the enterprise. The system status display 800 also includes data about each individual noise sensor (both stationary and mobile), such as a sensor status (e.g., operational, failed, mobile, etc.) and a current batter power level associated with that sensor. The system status display 800 further includes device-level dashboard information 850 that may, according to some embodiments, be selected by an operator to see a greater level of detail about that particular device. According to some embodiments, the display 800 (or the device itself) might generate an alarm when a sensor device is not operating properly (e.g., by flashing a light, emitting a beep, etc.).

Embodiments described herein may be associated with various types of enterprises. For example, a music venue, a night club, an airport, a demolition team, an outdoor construction site, etc. might all be interested in monitoring and/or processing noise level exposure information.

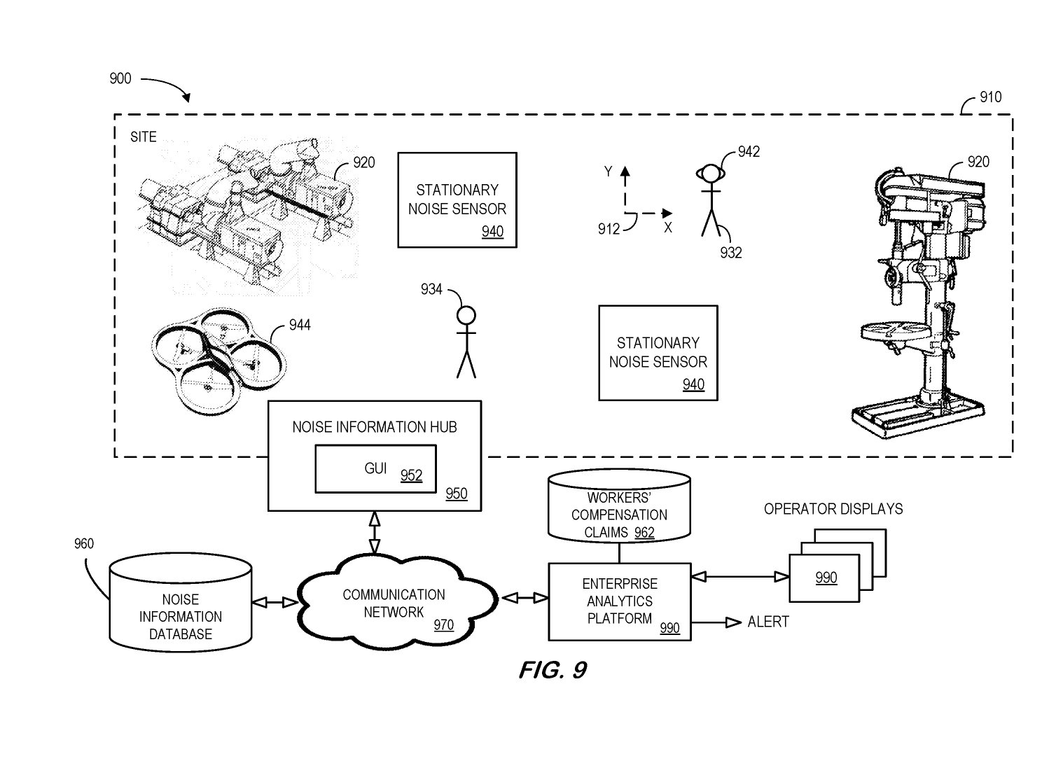

FIG. 9 is block diagram of a system 900 associated with an industrial workplace or factory 910 where machinery 920 is operated by workers 932, 934 (e.g., creating noise) according to some embodiments. As before, the system 800 includes a noise information hub 950 that receives information from a plurality of stationary noise sensors 940 and/or mobile noise sensors 942, 944. Note that the machinery 920 and workers 932. 934 may move around to various locations within the factory 910 (e.g., as indicated by axis 912). Further note that a mobile noise sensor might be associated with a worker (e.g., mobile sensor headphones 942 are worn by worker 932) or may be independently mobile (e.g., a self-navigating drone 944).

According to some embodiments, the noise information hub 950 exchanges data with a noise information database 960 and/or an enterprise analytics platform via a communication network 970. For example, a GUI 982 of the noise information hub 950 may transmit information to facilitate a rendering of an interactive graphical operator interface display 990 and/or the creation of electronic alert messages, automatically created employee and/or site recommendations, etc. The noise information hub 950 and/or enterprise analytics platform 980 may, according to some embodiments, be associated with an insurance provider.

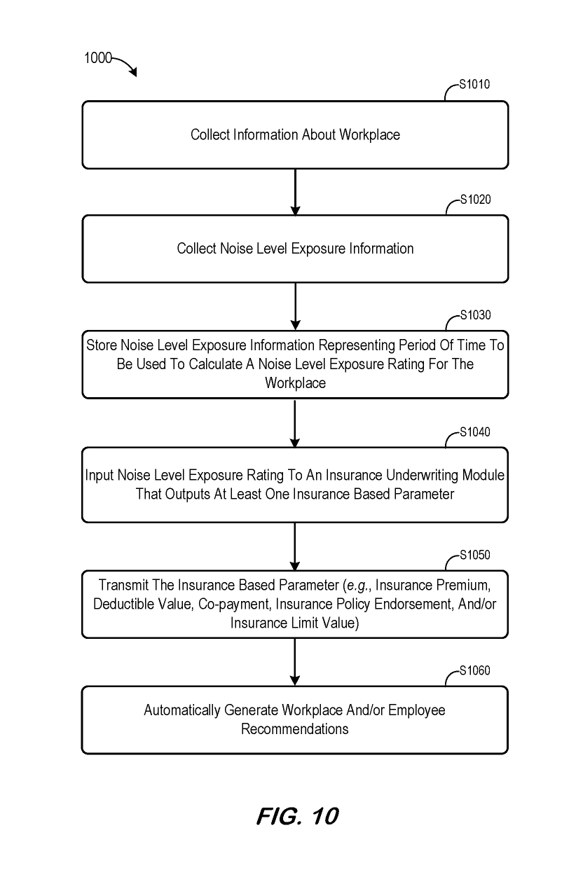

According to some embodiments, an overall noise level exposure rating may be used as an input to an insurance underwriting module that generates at least one insurance based parameter. FIG. 10 illustrates an insurance rating method 1000 that might be performed in accordance with some embodiments. At S1010, information about a workplace may be collected (e.g., associated with a type of industry, a number of employees, a building size, etc.). At S1020, noise level exposure information may be collected (e.g., in accordance with any of the embodiments described herein). At S1030, noise level exposure information may be stored to represent a period of time to be used to calculate a noise level exposure rating for the workplace. For example, a numerical rating or a rating category might be automatically calculated (e.g., a workplace may receive a “yellow” light indicating a moderate risk of hearing damage). At S1040, the noise level exposure rating is input to an insurance underwriting module that outputs at least one insurance based parameter. For example, the insurance underwriting module might automatically calculate an insurance premium based at least in part on the noise level exposure rating. At S1050, the system transmits an indication of the insurance based parameter (e.g., associated with an insurance premium, a deductible value, a co-payment, an insurance policy endorsement, and/or an insurance limit value). For example, an employer classified as “not noisy” might receive a percent or fixed premium discount for disability insurance (e.g., because fewer hearing-related claims might be expected as compared to “very noisy” employers). At S1060, the system may automatically generate and transmit workplace and/or employee recommendations. For example, an enterprise analytics platform might automatically recommend that a certain type of worker (e.g., an assembly line worker) spend 10 minutes each hour in a relatively quiet area to reduce the risk of hearing loss.

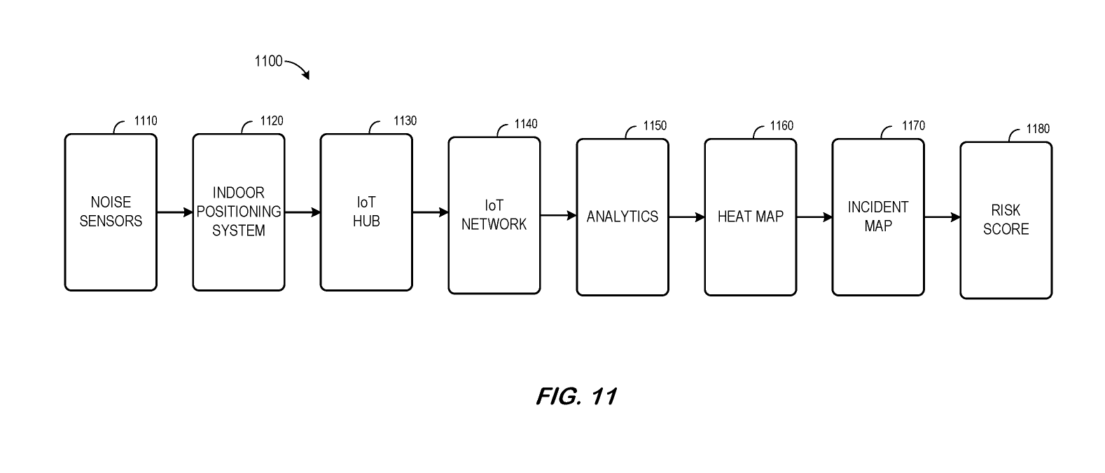

FIG. 11 is a flow diagram 1100 associated with an Internet of Things (“IoT”) approach according to some embodiments. At 1110, noise sensors (include, in some embodiments, wearable devices) may detect noise information in substantially real time (sensors may measure external sound levels, sound levels at a worker's ear, etc.). According to some embodiments, sensors may be mounted at fixed places in the workplace. Sound data may be continuously collected to understand the sound profile of the business.

At 1120, an indoor positioning system may provide location information. For example, beacons (e.g., Bluetooth enabled beacons for indoor locations) may transmit a Universally Unique Identifier (“UUID”) to IoT sensors/devices within range. At 1030, an IoT hub may collect noise data. The IoT hub might be associated with, for example, a smartphone able to receive Bluetooth or Wi-Fi signals, or a wireless router. Note that the noise data may be collected locally before being sent to one or more remote computers for processing. According to some embodiments, the IoT hub might encrypt locally stored data, transmit data via a cloud application using secure transport techniques, record battery levels for sensors and/or hub devices, and/or capture indoor location data.

At 1140, an IoT network may be used to transfer the collected noise data. For example, data may be transferred in accordance with a Message Queuing Telemetry Transport (“MQTT”) light weight messaging protocol for use on top of the TCP/IP protocol. The IoT network may register/configure IoT devices for a given customer and/or location. The IoT network may also receive noise exposure data streamed directly from IoT devices.

At 1150, information analytics may be performed on the collected noise data. Note that data collected at a cloud-based application center may be analyzed based on requirement in substantially real time to generate alerts. This process may also persist the noise exposure data and/or provide real time (as well as periodic) analytics on the noise data. At 1160, a noise heat map display may be created. According to some embodiments, the system may continuously collect and store noise level exposure data, equipment information, location data, noise patterns, etc. along with any noise events and/or alerts. The system may then provide a site-level heat map dashboard that provides, daily, weekly, monthly data, etc. According to some embodiments the collected data may include location, time, noise, noise pattern, role, tasks, equipment usage, event type, etc. At 1170, a noise incident map display may be created. At 1180, a noise risk score may be automatically calculated (e.g., using a risk-score model based on noise incident maps and noise exposure data).

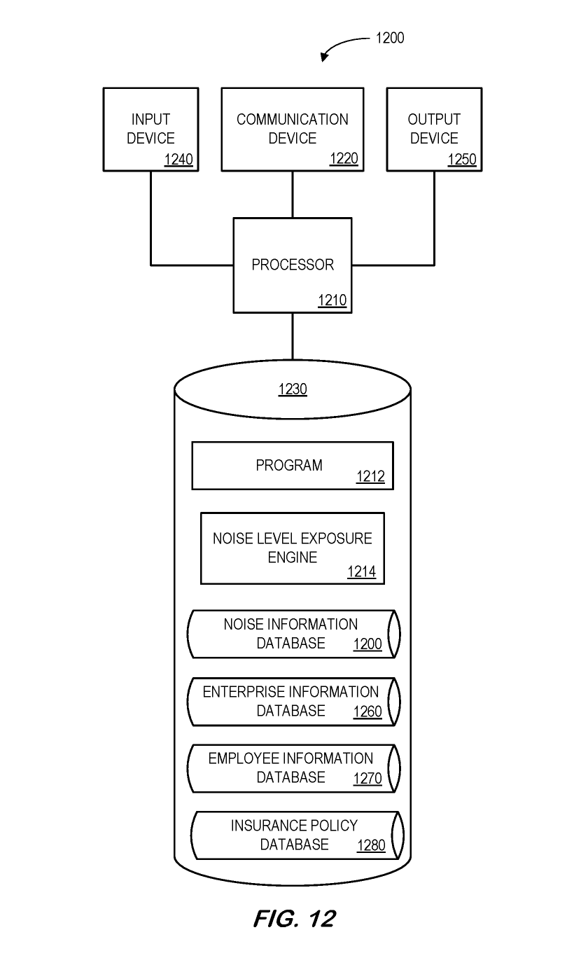

The embodiments described herein may be implemented using any number of different hardware configurations. For example, FIG. 12 illustrates an enterprise analytics platform 1200 that may be, for example, associated with the systems 100, 900 of FIGS. 1 and 9, respectively. The enterprise analytics platform 1200 comprises a processor 1210, such as one or more commercially available Central Processing Units (CPUs) in the form of one-chip microprocessors, coupled to a communication device 1220 configured to communicate via a communication network (not shown in FIG. 12). The communication device 1220 may be used to communicate, for example, with one or more remote noise sensors, noise information hubs, etc. Note that communications exchanged via the communication device 1220 may utilize security features, such as those between a public internet user and an internal network of the insurance enterprise. The security features might be associated with, for example, web servers, firewalls, and/or PCI infrastructure. The enterprise analytics platform 1200 further includes an input device 1240 (e.g., a mouse and/or keyboard to enter information about noise sensors and/or employees) and an output device 1250 (e.g., to output reports regarding system administration, noise alerts, workplace modification recommendations, insurance policy premiums, etc.).

The processor 1210 also communicates with a storage device 1230. The storage device 1230 may comprise any appropriate information storage device, including combinations of magnetic storage devices (e.g., a hard disk drive), optical storage devices, mobile telephones, and/or semiconductor memory devices. The storage device 1230 stores a program 1212 and/or a noise level exposure engine or application 1214 for controlling the processor 1210. The processor 1210 performs instructions of the programs 1212, 1214, and thereby operates in accordance with any of the embodiments described herein. For example, the processor 1210 may automatically use a plurality of stationary noise sensors (each including a microphone to sense noise, a power source, and a communication device to transmit data about noise sensed by the microphone) to collect noise data. Similarly, the processor 1210 may use a plurality of mobile noise sensors (each including a microphone to sense noise, a power source, and a communication device to transmit data about noise sensed by the microphone) to collect noise data. A noise information hub may receive data from the stationary noise sensors and mobile noise sensors and provide indications associated with the received data via a cloud-based application. The processor 1210 may receive these indications and analyze them to determine noise level exposure information for each of a plurality of locations within a workplace. The processor 1210 may also transmit information to facilitate rendering of an interactive graphical operator interface that displays a map-based presentation (e.g., a heat map display) of the noise level exposure information and prior noise-related results (e.g., workers' compensation insurance claims for hearing damage) for each of the locations.

The programs 1212, 1214 may be stored in a compressed, uncompiled and/or encrypted format. The programs 1212, 1214 may furthermore include other program elements, such as an operating system, a database management system, and/or device drivers used by the processor 1210 to interface with peripheral devices.

As used herein, information may be “received” by or “transmitted” to, for example: (i) the enterprise analytics platform 1200 from another device; or (ii) a software application or module within the enterprise analytics platform 1210 from another software application, module, or any other source.

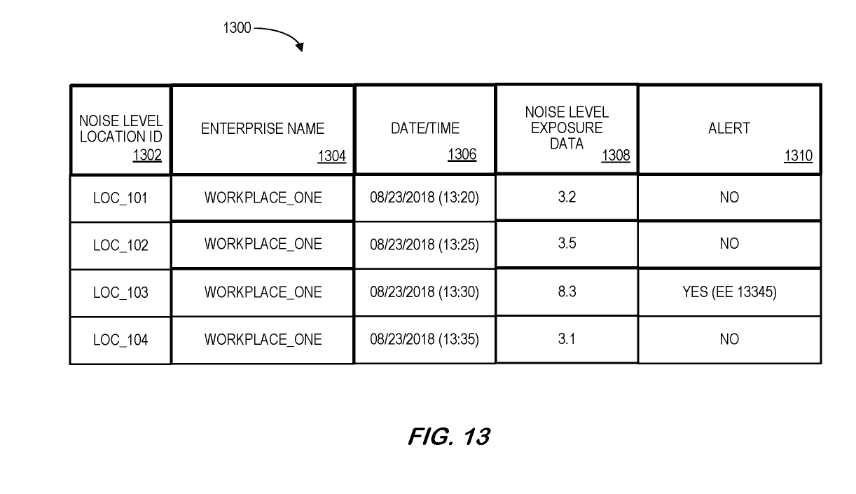

In some embodiments (such as shown in FIG. 12), the storage device 1230 includes a noise information database 1300, an enterprise information database 1260 (e.g., storing information about an industry type, a number of employees, work schedules, etc.), an employee information database 1270 (e.g., storing ages, genders, roles within a workplace, etc.), and an insurance policy database 1280 (e.g., storing information about past disability insurance claims, current premium values, etc.). An example of a database that may be used in connection with the enterprise analytics platform 1200 will now be described in detail with respect to FIG. 13. Note that the database described herein is only an example, and additional and/or different information may be stored therein. Moreover, various databases might be split or combined in accordance with any of the embodiments described herein. For example, the insurance policy database 1280 and/or noise information database 1300 might be combined and/or linked to each other within the noise level exposure engine 1214.

Referring to FIG. 13, a table is shown that represents the noise information database 1300 that may be stored at the enterprise analytics platform 1200 according to some embodiments. The table may include, for example, entries identifying noise sample collections. The table may also define fields 1302, 1304, 1306, 1308, 1310 for each of the entries. The fields 1302, 1304, 1306, 1308, 1310 may, according to some embodiments, specify: a noise level location identifier 1302, an enterprise name 1304, a date/time 1306, noise level exposure data 1308, and an alert indication 1310. The noise information database 1300 may be periodically created and updated, for example, based on information electrically received from noise sensors and/or a noise information hub via a cloud-based application.

The noise level location identifier 1302 and enterprise name 1304 may be, for example, unique alphanumeric codes identifying a particular worksite location for an enterprise (e.g., associated with a latitude/longitude, X/Y coordinate, etc.). The date/time 1306 and noise level exposure data 1308 might indicate a recorded level of audible activity at a particular time for a given sensor (e.g., stationary or mobile sensor). The alert indication 1310 might indicate whether or not an alert signal was transmitted responsive to the noise level exposure data 1308. For example, as illustrated by the third entry in the table 1300, an alert 1310 might be generated when noise level exposure data exceeds “5.5” for a given location/employee.

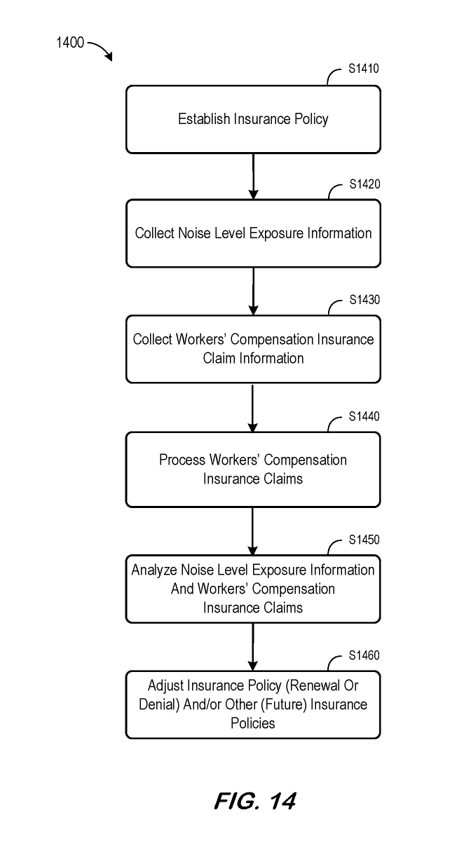

FIG. 14 illustrates an overall enterprise method 1400 that might be performed in accordance with some embodiments. At S1410, the enterprise may establish an insurance policy with an insured. For example, an insurance company may issue a workers' compensation insurance policy to a business. At S1420, the enterprise (either directly or with the help of the insured) may collect noise level exposure information. For example, the insurance company may measure the decibel levels of sounds that workers are exposed to throughout a factory. At S1430, the enterprise may collect workers' compensation insurance claim information (e.g., including a type of injury and/or potential causes of the injury). For example, workers' compensation insurance claim details, including indications of whether or not hearing injuries are involved, may be collected. At S1440, the enterprise may process workers' compensation insurance claims (e.g., making payments to workers as appropriate). At S1450, the enterprise may analyze noise level exposure information and workers' compensation insurance claims. Note that hearing injuries may, in some cases, take several years to develop (and thus, many years of noise level exposure information and associated insurance claim information may be collected and analyzed). At S1460, the enterprise may adjust the insurance policy (e.g., including a decision to renew, or not renew, various insurance policies) and/or other (future) insurance policies. For example, the insurance company might lower (or raise) an existing premium, adjust underwriting guidelines for a particular industry, etc. According to some embodiments, the willingness and ability of an enterprise to implement and/or enforce noise-related data collection might be indicative of an overall level of risk associated with that enterprise (e.g., associated with other types of insurance policies).

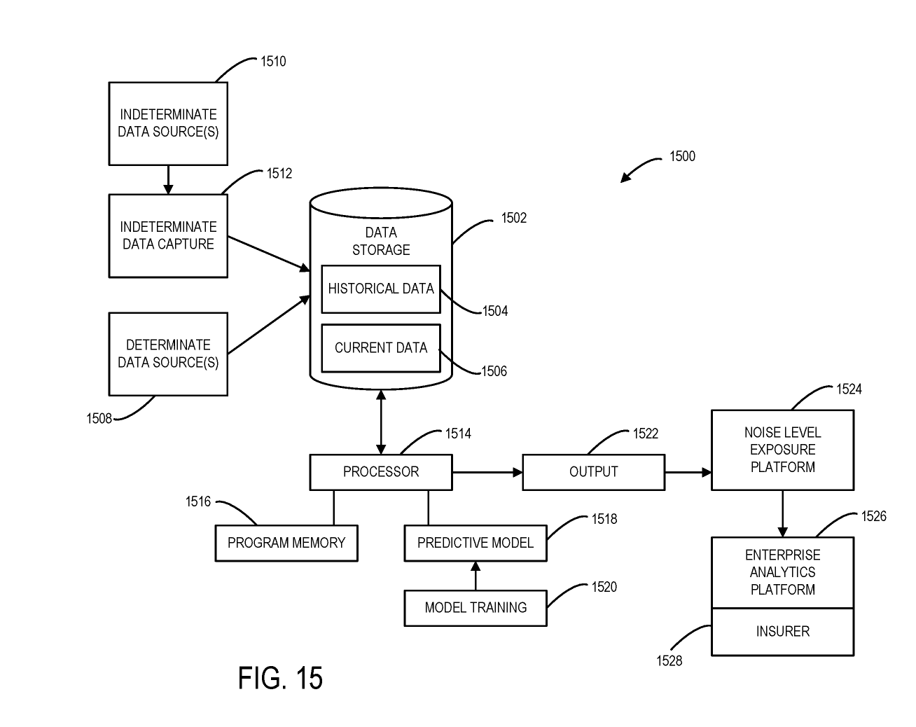

According to some embodiments, one or more predictive models may be used to generate noise models or help with underwrite insurance policies and/or predict potential hearing damage based on prior events and claims. Features of some embodiments associated with a predictive model will now be described by first referring to FIG. 15. FIG. 15 is a partially functional block diagram that illustrates aspects of a computer system 1500 provided in accordance with some embodiments of the invention. For present purposes it will be assumed that the computer system 1500 is operated by an insurance company (not separately shown) to support noise level exposure data monitoring and processing.

The computer system 1500 includes a data storage module 1502. In terms of its hardware the data storage module 1502 may be conventional, and may be composed, for example, by one or more magnetic hard disk drives. A function performed by the data storage module 1502 in the computer system 1500 is to receive, store and provide access to both historical claim transaction data (reference numeral 1504) and current claim transaction data (reference numeral 1506). As described in more detail below, the historical claim transaction data 1504 is employed to train a predictive model to provide an output that indicates potential noise level exposure patterns, and the current claim transaction data 1506 is thereafter analyzed by the predictive model. Moreover, as time goes by, and results become known from processing current claim transactions, at least some of the current claim transactions may be used to perform further training of the predictive model. Consequently, the predictive model may thereby adapt itself to changing event impacts and damage amounts.

Either the historical claim transaction data 1504 or the current claim transaction data 1506 might include, according to some embodiments, determinate and indeterminate data. As used herein and in the appended claims, “determinate data” refers to verifiable facts such as the an age of a home; a home type; an event type (e.g., fire or flood); a date of loss, or date of report of claim, or policy date or other date; a time of day; a day of the week; a geographic location, address or ZIP code; and a policy number.

As used herein, “indeterminate data” refers to data or other information that is not in a predetermined format and/or location in a data record or data form. Examples of indeterminate data include narrative speech or text, information in descriptive notes fields and signal characteristics in audible voice data files. Indeterminate data extracted from medical notes or accident reports might be associated with, for example, an amount of loss and/or details about damages.

The determinate data may come from one or more determinate data sources 1508 that are included in the computer system 1500 and are coupled to the data storage module 1502. The determinate data may include “hard” data like a claimant's name, date of birth, social security number, policy number, address; the date of loss; the date the claim was reported, etc. One possible source of the determinate data may be the insurance company's policy database (not separately indicated). Another possible source of determinate data may be from data entry by the insurance company's claims intake administrative personnel.

The indeterminate data may originate from one or more indeterminate data sources 1510, and may be extracted from raw files or the like by one or more indeterminate data capture modules 1512. Both the indeterminate data source(s) 1510 and the indeterminate data capture module(s) 1512 may be included in the computer system 1500 and coupled directly or indirectly to the data storage module 1502. Examples of the indeterminate data source(s) 1510 may include data storage facilities for document images, for text files (e.g., claim handlers' notes) and digitized recorded voice files (e.g., claimants' oral statements, witness interviews, claim handlers' oral notes, etc.). Examples of the indeterminate data capture module(s) 1512 may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an individual. For example, claim handlers' opinions may be extracted from their narrative text file notes.

The computer system 1500 also may include a computer processor 1514. The computer processor 1514 may include one or more conventional microprocessors and may operate to execute programmed instructions to provide functionality as described herein. Among other functions, the computer processor 1514 may store and retrieve historical claim transaction data 1504 and current claim transaction data 1506 in and from the data storage module 1502. Thus the computer processor 1514 may be coupled to the data storage module 1502.

The computer system 1500 may further include a program memory 1516 that is coupled to the computer processor 1514. The program memory 1516 may include one or more fixed storage devices, such as one or more hard disk drives, and one or more volatile storage devices, such as RAM devices. The program memory 1516 may be at least partially integrated with the data storage module 1502. The program memory 1516 may store one or more application programs, an operating system, device drivers, etc., all of which may contain program instruction steps for execution by the computer processor 1514.

The computer system 1500 further includes a predictive model component 1518. In certain practical embodiments of the computer system 1500, the predictive model component 1518 may effectively be implemented via the computer processor 1514, one or more application programs stored in the program memory 1516, and data stored as a result of training operations based on the historical claim transaction data 1504 (and possibly also data received from a third party reporting service). In some embodiments, data arising from model training may be stored in the data storage module 1502, or in a separate data store (not separately shown). A function of the predictive model component 1518 may be to determine appropriate simulation models, results, and/or scores (e.g., a rating indicating how noisy a workplace is compared to other workplaces in similar industries). The predictive model component may be directly or indirectly coupled to the data storage module 1502.

The predictive model component 1518 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 1500 includes a model training component 1520. The model training component 1520 may be coupled to the computer processor 1514 (directly or indirectly) and may have the function of training the predictive model component 1518 based on the historical claim transaction data 1504 and/or information about noise events, incidents, and alerts. (As will be understood from previous discussion, the model training component 1520 may further train the predictive model component 1518 as further relevant data becomes available.) The model training component 1520 may be embodied at least in part by the computer processor 1514 and one or more application programs stored in the program memory 1516. Thus the training of the predictive model component 1518 by the model training component 1520 may occur in accordance with program instructions stored in the program memory 1516 and executed by the computer processor 1514.

In addition, the computer system 1500 may include an output device 1522. The output device 1522 may be coupled to the computer processor 1514. A function of the output device 1522 may be to provide an output that is indicative of (as determined by the trained predictive model component 1518) particular noise heat maps, incidents, insurance underwriting parameters, and recommendations. The output may be generated by the computer processor 1514 in accordance with program instructions stored in the program memory 1516 and executed by the computer processor 1514. More specifically, the output may be generated by the computer processor 1514 in response to applying the data for the current simulation to the trained predictive model component 1518. The output may, for example, be a monetary estimate, a decibel level, and/or likelihood within a predetermined range of numbers. In some embodiments, the output device may be implemented by a suitable program or program module executed by the computer processor 1514 in response to operation of the predictive model component 1518.

Still further, the computer system 1500 may include a noise level exposure platform 1524. The noise level exposure platform 1524 may be implemented in some embodiments by a software module executed by the computer processor 1514. The noise level exposure platform 1524 may have the function of rendering a portion of the display on the output device 1522. Thus the noise level exposure platform 1524 may be coupled, at least functionally, to the output device 1522. In some embodiments, for example, the noise level exposure platform 1524 may direct workflow by referring, to an enterprise analytics platform 1526, employee recommendations, workplace modification recommendations, underwriting parameters, and/or alerts generated by the predictive model component 1518 and found to be associated with various results or scores. In some embodiments, this data may be provided to an insurer 1528 who may modify insurance parameters as appropriate.

Thus, embodiments may provide an automated and efficient way to facilitate monitoring and processing of noise level exposure data. The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

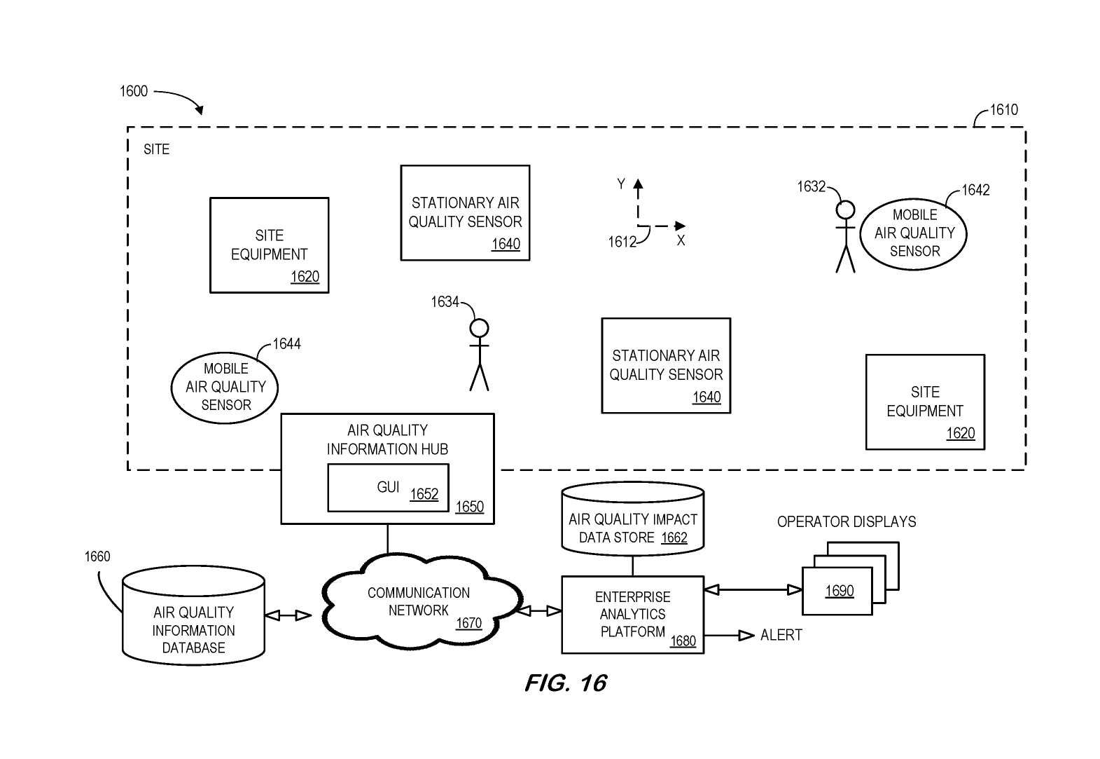

Some embodiments have been described herein as being associated with noise level detection systems. Note, however, that embodiments may be associated with other types of workplace detection systems. For example, FIG. 16 is block diagram of a system 1600 associated with a site 1610 where site equipment 1620 may be operated by workers 1632, 1634 (and which may impact air quality) according to some embodiments of the present invention. In particular, the system 1600 includes an air quality information hub 1650 that may receive information from a plurality of stationary air quality sensors 1640 and/or mobile air quality sensors 1642, 1644. Note that the site equipment 1620 and workers 1632, 1634 may be moved around to various locations within the site 1610 (e.g., as indicated by axis 1612). Further note that a mobile air quality sensor might be associated with a worker (e.g., mobile sensor 1642 might be worn by worker 1642) or may be independently mobile (e.g., a self-navigating sensor). As used herein, the phrase “air quality” might refer to any condition that could potentially impact a workers' health, such as carbon monoxide, airborne mold, chemicals, vapors, radiation, temperature, etc.

According to some embodiments, the air quality information hub 1650 exchanges data with an air quality information database 1660 and/or an enterprise analytics platform via a communication network 1670. For example, a GUI 1652 of the air quality information hub 1650 might transmit information to facilitate a rendering of an air quality display 1690 and/or the creation of electronic alert messages, automatically created employee and/or site recommendations, etc. According to some embodiments, the air quality information hub 1650 may instead store this information in a local database.

The air quality information hub 1650 and/or enterprise analytics platform 1680 may receive a request for a display from a requestor device. For example, an employer might use his or her smartphone to submit the request to the air quality information hub 1650. Responsive to the request, the air quality information hub 1650 might access information from the air quality information database 1660 (e.g., associated with air quality level exposures over a period of time). The air quality information hub 1650 and/or enterprise analytics platform 1680 may then use the GUI 1652 to render operator displays 1690. According to some embodiments, an operator may access secure site 1610 information through a validation process that may include a user identifier, password, biometric information, device identifiers, geographic authentication processes, etc. According to some embodiments, the enterprise analytics platform 1680 may further access electronic records from an air quality impact data store 1662. The air quality impact data store 1662 might, for example, store information about prior air quality-related results associated with an enterprise (and each result might be associated with a location of the enterprise).

The air quality information hub 1650 and/or enterprise analytics platform 1680 might be, for example, associated with a PC, laptop computer, smartphone, an enterprise server, a server farm, and/or a database or similar storage devices. The air quality information hub 1650 and/or enterprise analytics platform 1680 may, according to some embodiments, be associated with an insurance provider.

According to some embodiments, an “automated” air quality information hub 1650 may facilitate the provision of air quality exposure level information to an operator. For example, the air quality information hub 1650 may automatically generate and transmit electronic alert messages (e.g., when an air quality incident occurs) and/or site/employee recommendations.

As used herein, devices, including those associated with the air quality information hub 1650 and any other device described herein may exchange information via any communication network 1670 which may be one or more of a LAN, a MAN, a WAN, a proprietary network, a PSTN, a WAP network, a Bluetooth network, a wireless LAN network, and/or an IP network such as the Internet, an intranet, or an extranet. Note that any devices described herein may communicate via one or more such communication networks.

The air quality information hub 1650 and/or enterprise analytics platform 1680 may store information into and/or retrieve information from the air quality information database 1660. The air quality information database 1660 might be associated with, for example, an employer, an insurance company, an underwriter, or a claim analyst and might also store data associated with past and current insurance claims (e.g., workers' compensation benefit insurance claims). The air quality information database 1660 may be locally stored or reside remote from the air quality information hub 1650. As will be described further below, the air quality information database 1660 may be used by the air quality information hub 1650 to generate and/or calculate air quality level exposure data. Note that in some embodiments, a third party information service may communicate directly with the air quality information hub 1650 and/or enterprise analytics platform 1680. According to some embodiments, the air quality information hub 1650 communicates information associated with a simulator and/or a claims system to a remote operator and/or to an automated system, such as by transmitting an electronic file to an underwriter device, an insurance agent or analyst platform, an email server, a workflow management system, a predictive model, a map application, etc.

Although a single air quality information hub 1650 and enterprise analytics platform 1680 is shown in FIG. 16, any number of such devices may be included. Moreover, various devices described herein might be combined according to embodiments of the present invention. For example, in some embodiments, the air quality information hub 1650, enterprise analytics platform 1680, and/or air quality information database 1660 might be co-located and/or may comprise a single apparatus.

Note that the system 1600 of FIG. 16 is provided only as an example, and embodiments may be associated with additional elements or components. According to some embodiments, the elements of the system 1600 facilitate an exchange of information. According to some embodiments, data about air quality sensed by each of a plurality of “stationary” air quality sensors may be collected. Each stationary air quality sensor might include, for example, a microphone to sense air quality, a power source (e.g., associated with a battery, a re-chargeable battery, and/or an AC power adapter), and a communication device, coupled to the microphone and the power source, to transmit data about air quality sensed by each of the plurality of stationary air quality sensors. As used herein, a sensor may be stationary if it is not typically to move between locations (although the sensor might be occasionally moved from one location to another).

According to some embodiments, data about air quality sensed by each of a plurality of “mobile” air quality sensors may be collected. Each mobile air quality sensor might include, for example, a microphone to sense air quality, a power source (e.g., associated with a battery and/or a re-chargeable battery), and a communication device, coupled to the microphone and the power source, to transmit data about air quality sensed by each of the plurality of mobile air quality sensors. As used herein, a sensor may be mobile if it often moves from one location to another (although the sensor might remain at one location for a period of time). By way of example only, a mobile air quality sensor might be associated with a smartphone, a tablet computer, an activity tracker, a headphone or earmuff device, an earplug, a hardhat, a work vest, work shoes, safety goggles, a lanyard or badge, a clipboard, work gloves, a self-navigating device, and a drone.

According to some embodiments, an air quality information hub may receive data from the plurality of stationary air quality sensors and the plurality of mobile air quality sensors. The air quality information hub may also provide indications associated with the received data via a communication network (e.g., via a cloud-based application).

According to some embodiments, an enterprise analytics platform may receive the indications associated with the received data via the communication network. Moreover, the enterprise analytics platform may analyze the received indications to determine air quality level exposure information for each of a plurality of locations within a site of an enterprise. At S260, the enterprise analytics platform may correlate air quality level exposure information with prior air quality-related results (e.g., what levels of air quality level exposure resulted in a higher likelihood of a particular result occurring?). The results might be associated with, for example, workers' compensation insurance claims, quarterly hearing tests, etc. According to some embodiments, the enterprise analytics platform may transmit information to facilitate rendering of an interactive graphical operator interface that displays a map-based presentation of the air quality level exposure information and prior air quality-related results for each of the plurality of locations. According to some embodiments, the interactive graphical operator interface further includes indications of air quality level exposure incidents or events.

According to some embodiments, an enterprise analytics platform may also automatically generate an electronic alert message based on the air quality level exposure information. Moreover, the enterprise may be associated with an employer and the electronic alert message might further be based on: an employee location, an employee age, an employee gender, an industry standard, an employee protective equipment status, a length of time, a potential cause of an air quality level event, and/or an indication of a remedial action. According to some embodiments, selection of a location via the interactive graphical operator interface results in a display of detailed air quality level exposure information about that location.

In some embodiments, the enterprise analytics platform may store air quality level exposure information representing a period of time. Moreover, the air quality level exposure information representing the period of time might be used to calculate an air quality level exposure rating for the enterprise. According to some embodiments, the air quality level exposure rating is an input to an insurance underwriting module that outputs at least one insurance based parameter (e.g., associated with an insurance premium, a deductible value, a co-payment, an insurance policy endorsement, and/or an insurance limit value).

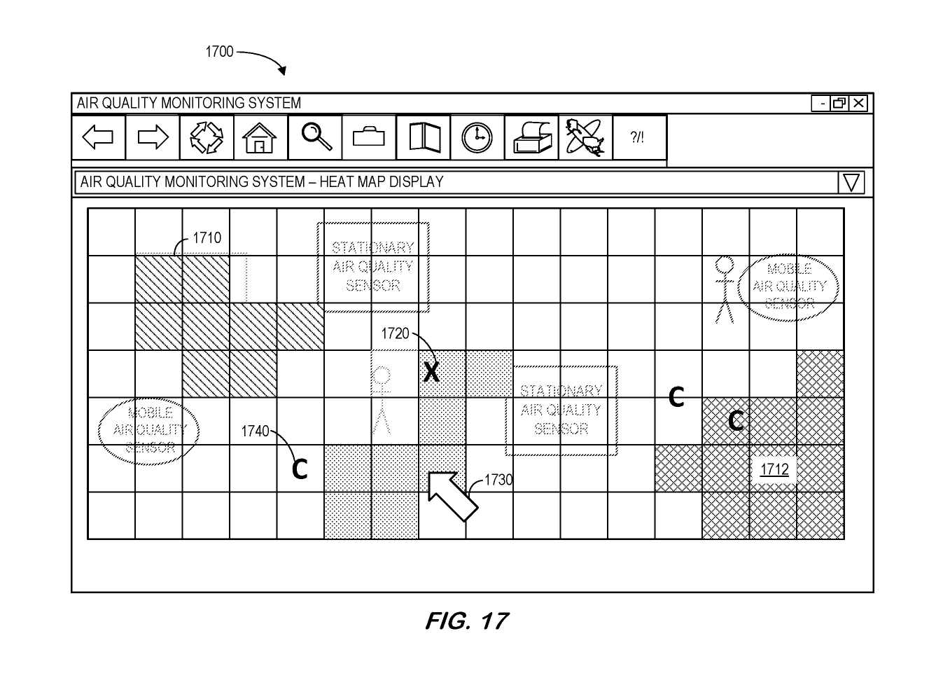

FIG. 17 illustrates an interactive operator air quality display 1700 in accordance with some embodiments. The air quality display 1700 includes a “heat map” type rendering including areas 1710, 1712 that signify particular levels of air quality exposure. In the example of FIG. 17, a first area 1710 might represent a potentially dangerous level of air quality exposure and/or a place where workers might need to take special precautions. According to some embodiments, the display 1700 may further include icons 1720 associated with an occurrence of an air quality incident (e.g., a location where it is known that an employee was exposed to a potentially harmful level of a chemical). In some embodiments, an operator of the display 1700 may use a computer pointer 1730 to select an area to receive more detailed information about air quality level exposure associated with that location. According to some embodiments, the display 1700 further includes indications of prior air quality related results 1740, such as workers' compensation insurance claims (“C”) that have been filed in connection with various locations.

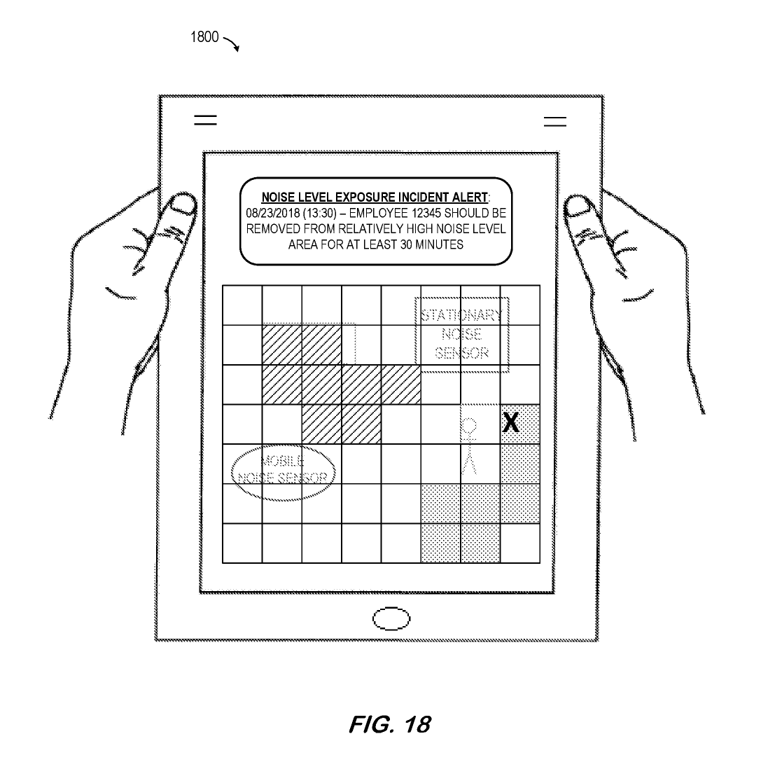

Although specific hardware and data configurations have been described herein, note that any number of other configurations may be provided in accordance with embodiments of the present invention (e.g., some of the information associated with a noise incidents and/or events might be implemented as an augmented reality display and/or the databases described herein may be combined or stored in external systems). Moreover, although embodiments have been described with respect to noise level exposure information, embodiments may instead be associated with other types of worker protection. For example, embodiments might be used in connection with lifting injuries (e.g., which might result in back problems or muscle sprains), radiation levels, carbon monoxide levels, mold hazards, lead exposure, etc. Still further, the displays and devices illustrated herein are only provided as examples, and embodiments may be associated with any other types of user interfaces. For example, FIG. 18 illustrates a handheld virtual heat map display 1800 according to some embodiments.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A system associated with a site of an enterprise, comprising:
a plurality of stationary noise sensors, each stationary noise sensor including:
a microphone to sense noise,
a power source, and
a communication device, coupled to the microphone and the power source, to transmit data about noise sensed by each of the plurality of stationary noise sensors;
a plurality of mobile noise sensors, each mobile noise sensor including:
a microphone to sense noise,
a power source, and
a communication device, coupled to the microphone and the power source, to transmit data about noise sensed by each of the plurality of mobile noise sensors;
a noise information hub to receive data from the plurality of stationary noise sensors and the plurality of mobile noise sensors and to provide indications associated with the received data via a communication network;
a noise impact data store containing electronic records associated with prior noise-related results, each result being associated with a location within the enterprise; and
an enterprise analytics platform, coupled to the noise impact data store, to receive the indications associated with the received data via the communication network, the enterprise analytics platform including a computer processor programmed to:
(i) analyze the received indications to determine noise level exposure information for each of a plurality of locations within the site of the enterprise,
(ii) correlate the noise level exposure information with the prior noise-related results in the noise impact data store, and
(iii) transmit information to facilitate rendering of an interactive graphical operator interface, the interactive graphical operator interface displaying a map-based presentation of the noise level exposure information and prior noise-related results for each of the plurality of locations.

2. The system of claim 1, wherein the power source of at least one of the stationary noise sensors comprises a battery, a re-chargeable battery, or an Alternating Current (“AC”) power adapter.

3. The system of claim 1, wherein at least one of the mobile noise sensors is associated with a smartphone, a tablet computer, an activity tracker, a headphone or earmuff device, an earplug, a hardhat, a work vest, work shoes, safety goggles, a lanyard or badge, a clipboard, work gloves, a self-driving device, and a drone.

4. The system of claim 1, wherein the interactive graphical operator interface further includes indications of noise level exposure events.

5. The system of claim 1, wherein the enterprise analytics platform is further to automatically generate an electronic alert message based on the noise level exposure information.

6. The system of claim 5, wherein the enterprise is associated with an employer and the electronic alert message is further based on at least one of: an employee location, an employee age, an employee gender, an industry standard, an employee protective equipment status, a length of time, a potential cause of a noise level event, and an indication of a remedial action.

7. The system of claim 1, wherein selection of a location via the interactive graphical operator interface results in a display of detailed noise level exposure information about that location.

8. The system of claim 1, wherein the enterprise analytics platform is further to store noise level exposure information representing a period of time.

9. The system of claim 8, wherein the noise level exposure information representing the period of time and noise-related results are to be used to calculate a noise level exposure rating for the enterprise.

10. The system of claim 9, wherein the noise-related results are associated with workers' compensation insurance claims and the noise level exposure rating is an input to an insurance underwriting module that outputs at least one insurance based parameter.

11. The system of claim 10, wherein the at least one insurance based parameter is associated with at least one of: an insurance premium, a deductible value, a co-payment, an insurance policy endorsement, and an insurance limit value.

12. A computerized method associated with a site of an enterprise, comprising:
collecting, via a plurality of stationary noise sensors, data about noise sensed by each of the plurality of stationary noise sensors;
collecting, via a plurality of mobile noise sensors, data about noise sensed by each of the plurality of mobile noise sensors;
receiving, at a noise information hub, the data from the plurality of stationary noise sensors and the plurality of mobile noise sensors;
providing, from the noise information hub, indications associated with the received data via a communication network;
receiving, by an enterprise analytics platform, the indications associated with the received data via the communication network;
analyzing, by the enterprise analytics platform, the received indications to determine noise level exposure information for each of a plurality of locations within the site of the enterprise;
accessing information in a noise impact data store containing electronic records associated with prior noise-related results, each result being associated with a location within the enterprise;
correlating the noise level exposure information with the prior noise-related results in the noise impact data store; and
transmitting, from the enterprise analytics platform, information to facilitate rendering of an interactive graphical operator interface, the interactive graphical operator interface displaying a map-based presentation of the noise level exposure information and prior noise-related results for each of the plurality of locations.

13. The method of claim 12, wherein the interactive graphical operator interface further includes indications of noise level exposure events.

14. The method of claim 12, wherein the enterprise analytics platform is further to automatically generate an electronic alert message based on the noise level exposure information.

15. The method of claim 14, wherein the enterprise is associated with an employer and the electronic alert message is further based on at least one of: an employee location, an employee age, an employee gender, an industry standard, an employee protective equipment status, a length of time, a potential cause of a noise level event, and an indication of a remedial action.

16. The method of claim 12, wherein selection of a location via the interactive graphical operator interface results in a display of detailed noise level exposure information about that location.

17. The method of claim 12, wherein the enterprise analytics platform is further to store noise level exposure information representing a period of time.

18. The method of claim 17, wherein the noise level exposure information representing the period of time is to be used to calculate a noise level exposure rating for the enterprise.

19. A system associated with a workplace, comprising:
a plurality of stationary noise sensors, each stationary noise sensor including a microphone to sense noise, a power source, and a communication device, coupled to the microphone and the power source, to transmit data about noise sensed by each of the plurality of stationary noise sensors;
a plurality of mobile noise sensors, each mobile noise sensor including a microphone to sense noise, a power source, and a communication device, coupled to the microphone and the power source, to transmit data about noise sensed by each of the plurality of mobile noise sensors;
a noise information hub to receive data from the plurality of stationary noise sensors and the plurality of mobile noise sensors and to provide indications associated with the received data via a cloud-based application;
a noise impact data store containing electronic records associated with prior noise-related results, each result being associated with a location within the enterprise; and
an analytics platform to receive the indications associated with the received data via the cloud-based application, the analytics platform including a computer processor programmed to:
(i) analyze the received indications to determine noise level exposure information for each of a plurality of locations within the workplace,
(ii) correlate the noise level exposure information with the prior noise-related results in the noise impact data store, and
(iii) transmit information to facilitate rendering of an interactive graphical operator interface, the interactive graphical operator interface displaying a map-based presentation of the noise level exposure information and prior noise-related results for each of the plurality of locations.

20. The system of claim 19, wherein the power source of at least one of the stationary noise sensors comprises a battery, a re-chargeable battery, or an Alternating Current (“AC”) power adapter.

21. The system of claim 20, wherein at least one of the mobile noise sensors is associated with a smartphone, a tablet computer, an activity tracker, a headphone or earmuff device, an earplug, a hardhat, a work vest, work shoes, safety goggles, a lanyard or badge, a clipboard, work gloves, a self-driving device, and a drone.
